(19) United States
(12) Patent Application Publication
(10) Pub. No.: US 2014/0311097 A1
(43) Pub. Date: Oct. 23, 2014

(54) DEVICE FOR COVERING A DOOR TO PROVIDE FOR SMOKE AND ODOR INSULATION AND METHOD FOR USING AND PACKAGING SAME

(71) Applicant: Nicolas J. Etienne, New York, NY (US)

(72) Inventor: Nicolas J. Etienne, New York, NY (US)

(21) Appl. No.: 14/185,462

(22) Filed: Feb. 20, 2014

Related U.S. Application Data
(60) Provisional application No. 61/767,460, filed on Feb. 21, 2013.

(51) Int. Cl. E06B 3/30; B65B 5/04

(52) U.S. Cl. CPC E06B 3/30; B65B 5/04
USPC 53/429; 428/343; 428/138; 428/136; 428/134; 428/35.7

(57) ABSTRACT

A device for covering a door of an entryway when the door is in a closed position, comprising a rectangular sheet pre-cut to a predetermined length and width, and a pressure sensitive adhesive coated onto one side of the rectangular sheet. The pressure sensitive adhesive is spaced apart from an edge of the rectangular sheet and extends around an entire perimeter of the rectangular sheet.

### CROSS-REFERENCE TO RELATED APPLICATION

This application claims the benefit of U.S. Provisional Patent Application Ser. No. 61/767,460, filed on Feb. 21, 2013, the contents of which are herein incorporated by reference in their entirety.

### BACKGROUND

1. Technical Field

The present disclosure relates to a device that is applied to cover a door when the door is in a closed position and a method for using and packaging same.

2. Discussion of the Related Art

It is often the case that occupants of apartments, offices, and/or different rooms of a house may seek to prevent odors, and/or secondary smoke, for example, from cigarettes, cigars and/or pipes, from other parts of a building from entering the apartment, office and/or room that a user is occupying. Conversely, the occupants of the apartments, offices, and/or different rooms of a building may seek to prevent odors, and/or secondary smoke from exiting their apartment, office and/or room and traveling to other parts of the building.

Accordingly, there is a need for a device that will provide such smoke and odor insulation.

### SUMMARY

A device for covering a door of an entryway when the door is in a closed position, according to an exemplary embodiment of the present invention, comprises a rectangular sheet pre-cut to a predetermined length and width, and a pressure sensitive adhesive coated onto one side of the rectangular sheet. The rectangular sheet may comprise a plastic.

The pressure sensitive adhesive may be one of a tacking compound, mounting tape, a mounting strip, and a conductive pressure sensitive adhesive, and may be reusable.

The pressure sensitive adhesive can be spaced apart from an edge of the rectangular sheet and extend around an entire perimeter of the rectangular sheet.

The predetermined length and width of the rectangular sheet may be larger than a length and width of the door.

The rectangular sheet can include an opening corresponding to a location of a door knob or door handle, wherein the opening is in the shape of a slit, an oval or a circle, and wherein the door knob or door handle is inserted through the opening upon covering the door with the rectangular sheet.

The rectangular sheet can include a pocket corresponding to a location of a door knob or door handle, wherein the door knob or door handle is inserted into the pocket upon covering the door with the rectangular sheet.

A method of packaging a device for covering a door of an entryway when the door is in a closed position, in accordance with an embodiment of the present invention, comprises adding a plurality perforations to a length of plastic material to separate the length of plastic material into a plurality of rectangular sheets, wherein each of the rectangular sheets has a predetermined length and width, folding the length of plastic material a plurality of times to reduce a width of the length of plastic material, rolling the folded length around a cylindrical roller, and inserting the cylindrical roller including the folded length into a box.

The length of the plastic material can be folded at least four times, wherein each fold has the same dimensions.

### BRIEF DESCRIPTION OF THE DRAWINGS

Exemplary embodiments of the present invention will be described below in more detail, with reference to the accompanying drawings, of which:

FIG. 1 shows a non-adhesive side of device for covering a door, according to an embodiment of the present invention;

FIG. 2 shows an adhesive side of a device for covering a door, according to an embodiment of the present invention;

FIG. 3 shows details of a pressure sensitive adhesive (PSA) in area A of FIG. 2 on a device for covering a door, according to an embodiment of the present invention;

FIG. 4 shows a package for a device for covering a door, according to an embodiment of the present invention;

FIG. 5 shows a method for packaging a device for covering a door, according to an embodiment of the present invention; and

FIG. 6 shows a non-adhesive side of a device for covering a door, according to an embodiment of the present invention.

### DETAILED DESCRIPTION OF EXEMPLARY EMBODIMENTS

Exemplary embodiments of the present invention now will be described more fully hereinafter with reference to the accompanying drawings. This invention may, however, be embodied in many different forms and should not be construed as limited to the embodiments set forth herein.

The present disclosure relates to a device that is applied to cover a door when the door is in a closed position and a method for using and packaging same. The door may be, for example, a door that is opened to gain entrance to a room, office, apartment and/or house. The door cover prevents smoke, such as, for example, cigarette smoke, and/or odors from exiting or entering the room, apartment or house.

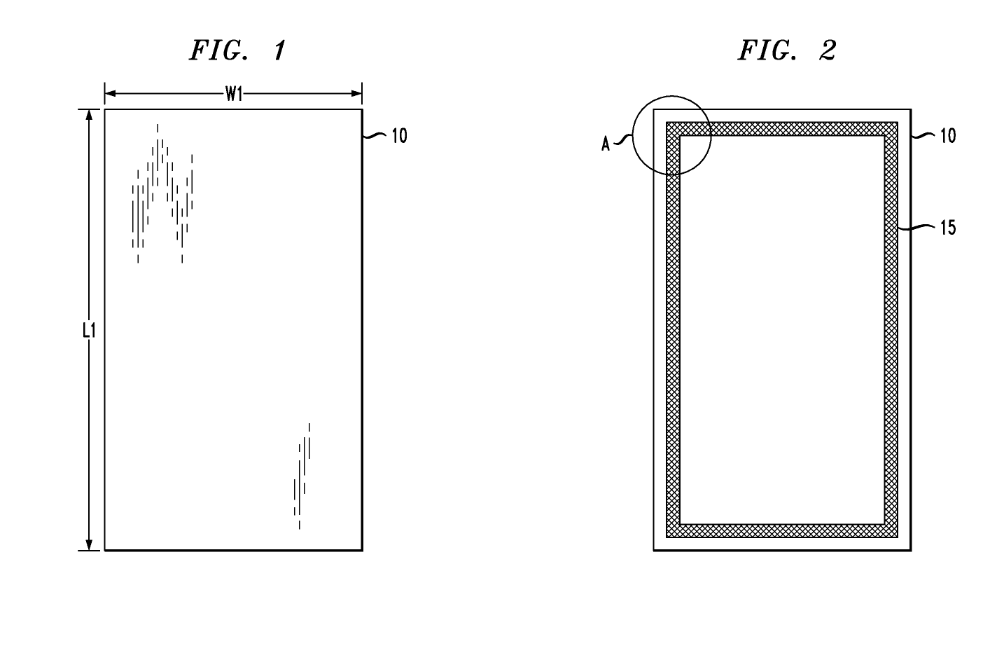

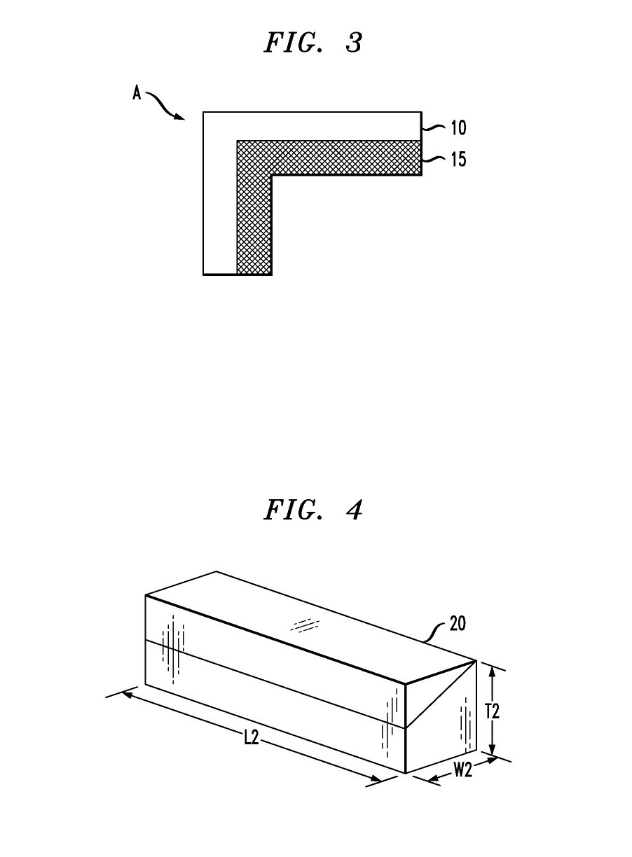

Referring to FIGS. 1, 2 and 6, the device comprises a pre-cut rectangular sheet 10, 100 that is pre-cut to, for example, about 35 to about 45 inches wide (width indicated by W1 in FIG. 1) by about 80 to about 95 inches long (length indicated by L2 in FIG. 1). In accordance with an exemplary embodiment, the sheet 10, 100 is pre-cut to about 42 inches wide by about 90 inches long. The sheet 10, 100 comprises a plastic material, such as, for example, polyethylene. Referring to FIGS. 2 and 3, the sheet 10, 100 includes a pressure sensitive adhesive (PSA) 15 that is coated onto one side of the sheet 10, 100. According to an embodiment, the PSA 15 can be, for example, a tacking compound, such as putty, mounting tape, mounting strips, a conductive PSA (CPSA), or any type of adhesive that can adhere an object to a surface with the application of some pressure, and allow for removal from the surface without damage to or residue on the surface. According to an embodiment, the PSA 15 may be reusable. The PSA 15 is spaced apart from an edge of the sheet 10, 100. For example, according to an embodiment, the PSA 15 is spaced apart about one inch from top and bottom and left and right edges of the sheet 10, 100, and extends around an entire perimeter of the sheet 10, 100. According to an embodiment, a width of the PSA 15 is about 1 inch on all sides.

According to an embodiment, the PSA 15 forms a temporary bond with a surface to which it is applied without leaving residue. Prior to use, the PSA 15 is covered by a release liner, which protects the adhesive until the release liner is removed and the cover is in use.

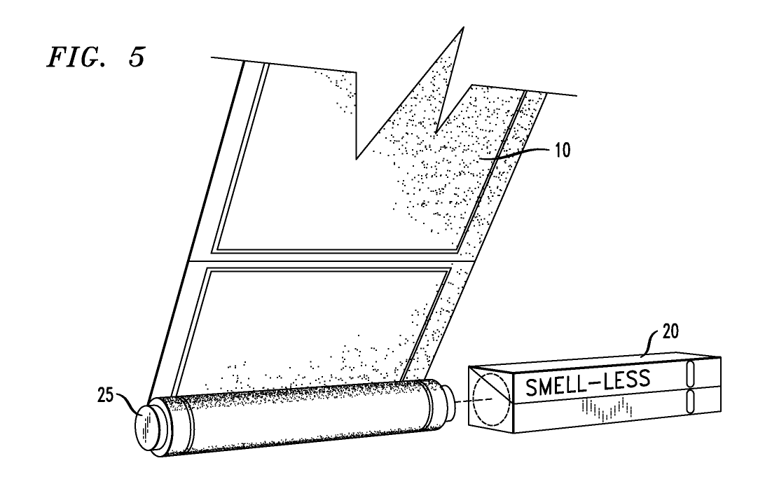

Referring to FIGS. 4 and 5, packaging for the sheets 10, 100 comprises, for example, a box 20, which is, according to an embodiment, about 1 foot long (indicated by L2 in FIG. 4), about 3 inches tall (indicated by T2 in FIG. 4) and about 3 inches wide (indicated by W2 in FIG. 4). The dimensions of the box 20 are not limited to these dimensions, and may vary depending on, for example, the number of sheets 10 in each box 20, and/or the configuration of the sheets 10, 100 in the box 20. The box 20 can be made of a recyclable material, such as, for example, paper and/or cardboard.

According to an embodiment, in the box that is 1 foot×3 inches×3 inches, the 42 inch by 90 inch sheets 10, 100 are folded four times to reduce the width from 42 inches to 10.5 inches, so as to fit into a 1 foot long box 20. Referring to FIG. 5, the four times folded sheets 10, 100 are rolled around a roller tube 25 into a cylinder. According to an embodiment, a plurality of sheets 10, 100, each 90 inches long, are rolled around the roller tube 25, and are perforated at 90 inch intervals, for easy removal of a 90 inch long sheet upon unrolling the cylinder and tearing off the 90 inch section.

In use, a sheet 10, 100 removed from the box 20 is applied to a door by unfolding the sheet 10, 100 and removing the release liner from the PSA 15 to expose the PSA 15. The PSA 15 is then pressed onto surfaces around a door, such as, for example, moldings, walls and/or floors to adhere the sheet 10, 100 to these surfaces. The width and length of the sheet 10, 100 is larger than the door to which the sheet 10, 100 is being applied, so that the sheet can adhere to the surfaces around the door, resulting in the sheet 10, 100 covering an entire door and spaces around the door, such as, for example, the space between the door and the floor.

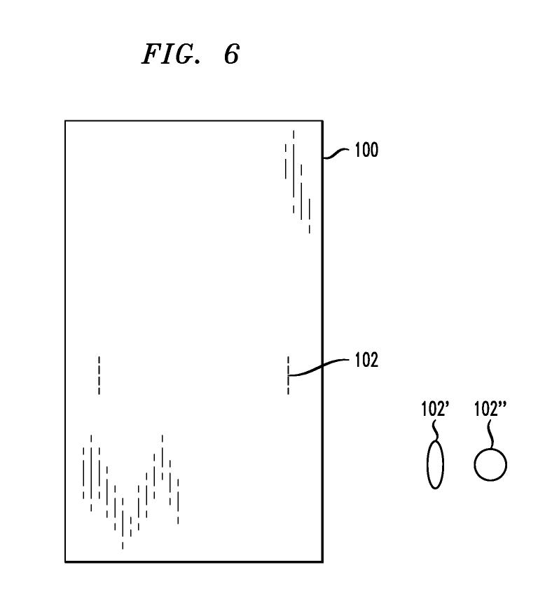

Referring to FIG. 6, according to an embodiment, the sheet 100 can include an opening 102, such as a slit, or a pocket at the location of a door knob to allow for a more flush application of the sheet 100 to the door. The opening 102 can be located on left and/or right sides of the sheet 100 so that the sheet 100 can be applied to a left-hand and right-hand opening door. As noted, the opening 102 can have different shapes, such as a slit (shown by dotted lines) and oval and circular shapes 102′ and 102″. The pocket include extra material at a location corresponding to the door knob to receive the door knob therein.

On the side of the sheet 10, 100 which faces a user and faces away from the door, the sheet 10, 100 can have an image of a door, ally, cave or other fun scenes or artwork. The image can be, for example, 36 inches×80 inches, which is a common door size.

Although exemplary embodiments of the present invention have been described hereinabove, it should be understood that the present invention is not limited to these embodiments, but may be modified by those skilled in the art without departing from the spirit and scope of the present invention.

What is claimed is:

1. A device for covering a door of an entryway when the door is in a closed position, comprising:
a rectangular sheet pre-cut to a predetermined length and width; and
a pressure sensitive adhesive coated onto one side of the rectangular sheet.

2. The device according to claim 1, wherein the rectangular sheet comprises a plastic.

3. The device according to claim 1, wherein the pressure sensitive adhesive is one of a tacking compound, mounting tape, a mounting strip, and a conductive pressure sensitive adhesive.

4. The device according to claim 1, wherein the pressure sensitive adhesive is reusable.

5. The device according to claim 1, wherein the pressure sensitive adhesive is spaced apart from an edge of the rectangular sheet and extends around an entire perimeter of the rectangular sheet.

6. The device according to claim 1, wherein the predetermined length and width of the rectangular sheet is larger than a length and width of the door.

7. The device according to claim 1, wherein the rectangular sheet includes an opening corresponding to a location of a door knob or door handle,

8. The device according to claim 7, wherein the opening is in the shape of a slit, an oval or a circle.

9. The device according to claim 7, wherein the door knob or door handle is inserted through the opening upon covering the door with the rectangular sheet.

10. The device according to claim 1, wherein the rectangular sheet includes a pocket corresponding to a location of a door knob or door handle.

11. The device according to claim 10, wherein the door knob or door handle is inserted into the pocket upon covering the door with the rectangular sheet.

12. A method of packaging a device for covering a door of an entryway when the door is in a closed position, the method comprising:
adding a plurality perforations to a length of plastic material to separate the length of plastic material into a plurality of rectangular sheets, wherein each of the rectangular sheets has a predetermined length and width;
folding the length of plastic material a plurality of times to reduce a width of the length of plastic material;
rolling the folded length around a cylindrical roller; and
inserting the cylindrical roller including the folded length into a box.

13. The method according to claim 12, wherein the length of the plastic material is folded at least four times.

14. The method according to claim 13, wherein each fold has the same dimensions.
